(19) United States
(12) Patent Application Publication
(10) Pub. No.: US 2025/0123379 A1
(43) Pub. Date: Apr. 17, 2025

(54) DEVICE AND METHOD FOR TESTING A LIDAR SENSOR

(71) Applicant: dSPACE GmbH, Paderborn (DE)

(72) Inventors: Andreas HIMMLER, Paderborn (DE); Stefan SCHUKAT, Paderborn (DE); Rainer WOLSFELD, Borchen (DE); Jan LACHMAIR, Bielefeld (DE); Christian PILGER, Bielefeld (DE)

(73) Assignee: dSPACE GmbH, Paderborn (DE)

(21) Appl. No.: 18/916,632

(22) Filed: Oct. 15, 2024

(30) Foreign Application Priority Data
Oct. 13, 2023 (DE) 10 2023 128 069.4

(51) Int. Cl. G01S 7/497; G01S 7/481

(52) U.S. Cl. CPC G01S 7/497; G01S 7/4812; G01S 7/4814

(57) ABSTRACT

A device for testing a lidar sensor. The lidar sensor being configured to emit first light having a first wavelength. A trigger detector is configured to receive the first light on a first optical path, the trigger detector being configured to generate a trigger signal as a function of the received first light. At least one transmitter is configured to emit second light, having a second wavelength, as a function of the trigger signal, the second light being receivable on a second optical path by the lidar sensor. A first optical element is configured to separate the first optical path from the second optical path. A second optical element is situated in the second optical path and is configured to apply a diffuse reflection and/or transmission to the second light.

This nonprovisional application claims priority under 35 U.S.C. § 119 (a) to German Patent Application No. 10 2023 128 069.4, which was filed in Germany on Oct. 13, 2023, and which is herein incorporated by reference.

### BACKGROUND OF THE INVENTION

### Field of the Invention

The present application relates to a device and a method for testing a lidar sensor, and to a test stand, in particular a roller test stand, for testing the lidar sensor.

### Description of the Background Art

A device and a method for isolating a trigger signal for a test system of a lidar sensor are described in DE 102021106220 A1, which corresponds to US 2022/0291355, which is incorporated herein by reference. An optical element is provided which is arranged in front of a converging lens or a trigger detector and situated in a signal path of the trigger signal. The optical element is designed to allow the trigger signal to pass through, and to at least partially absorb a back reflection of the trigger signal that passes through the optical element and that is reflected in particular at a surface. The polarization of the light is utilized for this purpose. The optical element may be designed as an optical isolator, in particular as a Faraday isolator, wherein the Faraday rotator in this case is situated between a first polarizer and a second polarizer.

### SUMMARY OF THE INVENTION

It is therefore an object of the present invention to provide a device and method for testing a lidar sensor.

A lidar sensor is configured to emit first light having a first wavelength.

An exemplary device for testing the lidar sensor can comprise: a trigger detector that is configured to receive the first light on a first optical path, the trigger detector being configured to generate a trigger signal as a function of the received first light; at least one transmitting device that is configured to emit second light, having a second wavelength, as a function of the trigger signal, the second light being receivable on a second optical path by the lidar sensor; a first optical element that is configured to separate the first optical path from the second optical path; a second optical element that is situated in the second optical path and that is configured to apply a diffuse reflection and/or transmission to the second light.

An exemplary method for testing a lidar sensor can comprise: emitting first light, having a first wavelength, by the lidar sensor; receiving the first light on a first optical path by a trigger detector; generating a trigger signal by the trigger detector as a function of the received first light; emitting second light, having a second wavelength, by at least one transmitting device as a function of the trigger signal; and receiving the second light on a second optical path by the lidar sensor, wherein a first optical element separates the first optical path from the second optical path, and wherein a second optical element applies a diffuse reflection and/or transmission to the second light in the second optical path.

In this way, a device and a method for testing a lidar sensor may be provided which have lower demands on accuracy concerning mechanical orientation and/or calibration. In addition, flexible adaptation and expansion of lidar test scenarios may be achieved, using the components of the device. In general, it is noted that the term “light” is to be broadly interpreted, and has been selected for better readability. Electromagnetic waves are intended, which may also be present in nonvisible wavelength ranges.

The described device and the described method for testing the lidar sensor allow the lidar sensor to be confronted, and thus tested, with various situations that may occur in reality. The situations are simulated for the lidar sensor by means of the second light. This type of testing may also be referred to as over-the-air (OTA) testing. It is thus possible to also check, for example, specified test cases that are prescribed by a contracting or regulatory authority, for example. The described device may be advantageously used in particular in a roller test stand in order to test a lidar sensor that is installed in a vehicle situated on the roller test stand.

With regard to assisted or autonomous driving, correct functioning of such a lidar sensor is imperative. The described device and the described method may be advantageously used to spare test drives and also to test, in a short period of time, a number of various traffic situations that may occur. The device and the method allow testing of the lidar sensor via an optical transmit/receive interface (over-the-air). This allows the lidar sensor to be tested, regardless of its installation and/or whether it is already installed, for example in a vehicle.

The lidar sensor emits the first light by means of a light source, for example laser light via one or more laser diodes. The lidar sensor then evaluates received second light. If the lidar sensor is in the operating mode for surroundings detection, the second light generally involves back reflections from the surroundings of the lidar sensor. However, the evaluation of the second light, for example via the so-called time-of-flight principle or also via a Doppler shift, also allows determination of distances as well as movements of objects in the visual field of the lidar sensor. Movement of the objects may in particular mean the direction, or also the speed or acceleration or other motion parameters. A lidar sensor is often used in conjunction with other sensors, for example a radar sensor and/or a camera sensor, to obtain the necessary redundancy and reliability of such information concerning the visible objects.

The lidar sensor can be configured to emit first light having a first wavelength. The present patent application describes how the wavelength may be used for the separation of the optical paths.

The trigger detector, which can be configured to receive the first light on a first optical path and to generate the trigger signal as a function of the received first light, has a receiver for the first light. The receiver of the trigger detector may convert the received first light into an electrical signal, for example, using an optical-electrical converter. For this purpose, the receiver may include photodiodes, other light-sensitive diodes, or electronic components, or also other optical-electrical converters such as a photomultiplier or an interferometer.

The at least one transmitting device can be configured to emit second light, having a second wavelength, as a function of the trigger signal, the second light being receivable on a second optical path by the lidar sensor. For example, the transmitting device includes laser diodes or conventional light-emitting diodes which emit the second light at the second wavelength. This emission is triggered by the trigger signal, which is an electrical signal, for example. The first wavelength and the second wavelength are in particular different, and may be used for the separation of the optical paths. The second light is received by the lidar sensor via the second optical path, the lidar sensor therefore likewise having an optical-electrical converter, for example photodiodes, PIN diodes, etc.

The device can be designed in such a way that the lidar sensor perceives the received second light as back reflection of its emitted first light. The received second light is evaluated by the lidar sensor and used for surroundings detection. By use of the second light that is transmitted by the transmitting device, it is thus possible for the lidar sensor to simulate the surroundings containing objects.

The separation of the first and second optical paths is advantageous, since the situation may be avoided that first light emitted by the lidar sensor is reflected at the at least one transmitting device, and this reflection is received by the lidar sensor. Due to this received reflection, the lidar sensor could perceive the at least one transmitting device as an object in its surroundings. This may be avoided by use of the described device and the described method.

The optical element can be provided for separation of the two optical paths. The separation is achieved in particular as a function of the first and second wavelengths. The optical path is the path followed by the first or second light when passing through the air as optical medium and when passing through the optical element. A characteristic of the separation of the first and second optical paths is, for example, that at least one of the optical paths undergoes at least one geometric change, for example a change in direction. The change in direction may also be only an angular change, for example, wherein the angular change is viewed with respect to the direction that the optical path has taken on the path between the first optical element and the lidar sensor.

The geometric change can be brought about by the first optical element, either directly or indirectly. “Directly” can mean that the optical path or the optical paths run(s) through the optical element and undergo(es) the geometric change. “Indirectly” can mean that the optical paths undergo the geometric change in direction outside the first optical element. The indirect change may take place in particular due to the interaction with further elements.

The first optical element may be situated in the first optical path and in the second optical path. The separation of the two optical paths is thus easily achievable, since both paths contain the optical element.

The second optical element, which can be situated in the second optical path and configured to apply a diffuse reflection and/or transmission to the second light, has the advantage that the mechanical precision of the structure may be less as a result of this scattering. It is then also possible, for example, for the device to have a very compact design. Due to the second optical element, sufficient second light can be emitted in the direction of the lidar sensor, even if the second light is not exactly aimed at the lidar sensor. This may be achieved by the scattering at the second optical element.

An even more compact design of the device may be achieved when a deflector for the second light is additionally situated in the second optical path. The deflector may be situated between the at least one transmitting device and the second optical element and/or between the second optical element and the lidar sensor and/or at some other location on the second optical path. The deflector may include, for example, one or more mirrors or other devices for optically deflecting light. Via multiple reflections, the second optical path may be lengthened in a small installation space. Alternatively or additionally, arrangement of such a deflector in the first optical path is possible.

“Diffuse reflection or transmission” can mean diffuse scattering, in which the second light is scattered in various directions based on the structure of the second optical element. In the diffuse reflection, the second light is diffusely reflected at the second optical element, for example a diffusely reflective screen or a reflective diffuser. In the diffuse transmission, the second light is diffusely transmitted at the second optical element, for example a diffusely transmitting screen. In the diffuse transmission or reflection, portions of the second light traveling in the direction of the lidar sensor remain, even if the second light is not optimally aimed at the lidar sensor.

In particular, the second optical element may have a diffusely transmitting design when the second optical element is situated between the at least one transmitting device and the lidar sensor, or between the at least one transmitting device and the first optical element. In this embodiment, the second light strikes the second optical element, is diffusely transmitted through it, and exits on the other side of the second optical element. Portions of the second light then reach the lidar sensor via the further second optical path.

In particular, the second optical element may have a diffusely reflective design when the at least one transmitting device is situated between the second optical element and the lidar sensor or the first optical element. In this embodiment, the second light strikes the second optical element and is diffusely reflected at same. Due to the diffuse reflection, portions of the second light on the further second optical path then reach the lidar sensor.

The second optical element may also have a diffusely reflective design and at the same time, a diffusely transmitting design. Such a second optical element may then be used, for example, in devices in which various transmitting devices are situated on various sides of the second optical element.

The second optical element can be situated between the at least one transmitting device and the first optical element. The second optical element is then configured to apply the diffuse reflection and/or transmission to the second light in the second optical path, on the side of the first optical element facing away from the lidar sensor. The first optical path is separated from the second optical path on the side of the first optical element facing away from the lidar sensor. The first optical element thus separates the optical paths or the first and the second light via a geometric change in the direction of at least one of the optical paths. This occurs with an effect on the side of the first optical element facing away from the lidar sensor. A side of the optical element facing the lidar sensor refers to the area between the optical element and the lidar sensor on the shortest path. It is possible for multiple sides to face away from the lidar sensor, depending on the shape of the optical element. In that case, the sides facing away from the lidar sensor are those sides which do not face the lidar sensor. These sides are all included in the stated facing-away side. This embodiment allows the first optical element, for example, to be mounted very near the lidar sensor, with the second optical element then behind it, which, for example, may have a less compact design than the first optical element. In this way, the second optical element, as the larger optical element, may be mounted farther away from the lidar sensor, and the device as a whole may have a compact design.

The second optical element can include a diffuser. A diffuser can bring about the scattering of the light at its surface. A diffuser, also referred to as a diffusing disc, is an optical component that is used to scatter light. The diffuser may have a semitransparent projection surface, for example. The effects utilized by the diffuser are the diffuse reflection and the refraction of light. It is characteristic of a diffuser that it has a large number of small scattering centers. For example, if parallel light beams strike at various locations on a diffuser, they are dispersed in different directions and thus generate diffuse light. Use is made of this effect for the described device and the described method.

The second optical element can include a screen. The screen can be a plane or a surface for making the incident light visible. Such screens may be specifically designed for such applications, and based on their characteristics may have a diffuse scattering reflection and/or transmission.

A change device can be provided which is configured to change the direction of the second light as a function of the object simulator. Thus, different scenarios for the lidar sensor may be tested by virtue of the change device changing, for the second light, the direction of this second light as a function of the object simulator. The change device may be designed in particular as a further optical element in the second optical path.

The change device may include mirrors that are suitable for changing the direction of the second light, and thus the course of the second optical path. It is then optionally possible for the position and orientation of the transmitting device to remain unchanged, and for only the second optical path to undergo a change in the direction due to the mirrors.

The change device may include an electromagnetically driven mirror, preferably a galvo mirror. The change in the direction may thus be brought about using this galvo mirror or the electromagnetically driven mirror. Galvo mirrors include so-called “galvos,” which are electromagnetically driven rotary axes having at their end a mirror for deflecting the light beams.

The change device may change the direction of the second light, for example via a movement, in particular a rotation/tilt, of the at least one transmitting device for the second light as a function of the object simulator. For this purpose, the change device may include a movement device that is designed to change the direction of transmission of the second light via a movement of the at least one transmitting device or at least one light source of the at least one transmitting device. Thus, via a movement of the light source itself and/or of the at least one transmitting device, the movement device changes the direction of the light. This may also take place via an electric motor, for example by tilting and/or rotating the light source.

The simulation of the objects for the lidar sensor may be further simplified by use of the change device in combination with the second optical element, since the mechanical processes for simulating the objects by the second optical element optionally do not have to be as accurate. These mechanical processes may optionally be reduced to the movement of the light sources, for example by mechanical rotation and/or on electromagnetically driven mirrors, for example using galvo mirrors.

Furthermore, it is possible for the at least one transmitting device to include a projector. The projector generates a real, enlarged projected image onto the second optical element. Such a projector may be designed as a digital micromirror device (DMD). This is a light modulator or also a spatial light modulator, which is made up of a matrix of arranged micromirrors with actuators, i.e., displaceable mirrored surfaces having an edge length of approximately 16 μm, for example. The movement in such systems is brought about by a force effect of electrostatic fields. The angle of the micromirror may be individually adjusted, and generally has two stable end states, between which it can alternate up to 5000 times per second. The number of mirrors corresponds to the resolution of the projected image, wherein a mirror may involve one or more pixels. In this way, objects in question for the lidar sensor may be generated on the second optical element, and regions may also be correspondingly darkened.

In such an example, the simulation of the objects for the lidar sensor may be simplified by use of the second optical element in combination with the projector, since the mechanical processes for simulating the objects by the second optical element do not have to be as accurate. The mechanical processes may optionally be reduced to optical darkening of subregions of the light source by the projector on the second optical element itself, for example by using projection technologies such as DMDs.

Furthermore, it is possible for the at least one transmitting device to include a field of light sources, the light sources being activatable independently of one another. A light source is the laser diode or light-emitting diode, for example, and a field of light sources is a so-called array of laser diodes or light-emitting diodes. An array of laser diodes or light-emitting diodes is also referred to as a laser diode array or light-emitting diode array.

A field of light sources may also be referred to as a transmit matrix, and for example may have a field of pixels that can emit light. The transmitting device may also have multiple transmit matrices. Optionally, the optical properties of the light of the individual pixels may be improved via microlenses in the case of fields of microlens arrays (MLAs), for example by better concentration or collimation. It is then possible, for example, to also individually control, for example, individual pixels of the transmit matrix or the transmit matrices of the at least one transmitting device.

The at least one transmitting device may include one laser diode or multiple laser diodes, for example as an array. For example, an individual laser diode in a field of laser diodes, i.e., a laser diode array of the transmit matrix, may be controlled and activated in this way. By use of the at least one transmitting device, this enables a high level of flexibility with regard to the simulated reflection signals of the simulated objects, also synthetic objects, that the lidar sensor sees in its visual range.

A laser array is manufacturable in mass production as a semiconductor product. In addition, controllability of the particular light sources is achievable by manufacturing using semiconductor technology, in that an activator for the particular laser diode are present. The activator can be designed to convert electrical signals into activation of the laser diode. The activation encompasses, for example, whether the laser diode emits second light at all, and if so, with what light intensity. However, other optical parameters of the second light may also be determined in this way. The activator may therefore be designed as one or more processors, for example. By use of saved test scenarios, it is thus possible to simulate any desired targets for testing the lidar sensor, based on the activation and movement of the at least one transmitting device.

Furthermore, it is possible for the at least one transmitting device and the trigger detector can be situated spatially separate from one another. This allows a particularly compact design of the device. Alternatively, it is possible to situate the trigger detector and the transmitting device on the same component. In addition to the separation of the first and second paths by the first optical element, further beam deflections may then be provided.

The first optical element may include a dichroic mirror. Dichroic mirrors are designed to combine or separate two or more light beams having different wavelengths. They may be designed as long-pass mirrors, for example, in which the long wavelengths are transmitted and the short wavelengths are reflected. In one design as a short-pass mirror, the short wavelengths are passed through and the long wavelengths are reflected. Dichroic mirrors may have an alternating layered structure. In the coating, metallic layers may alternate with dielectric layers. Alternatively, low-refractive and high-refractive dielectric layers may be used in alternation. Dichroic mirrors are also referred to as interference filters. Dichroic mirrors are able to reflect the light of a wavelength with very low loss, and are therefore suitable, for example, for lasers such as in lidar. For a dichroic mirror, the rate of reflection may be set very precisely and in practically any desired manner as a function of the wavelength by suitably selecting the number of layers, layer thickness, and/or refractive index of the dielectrics used, which is helpful for the desired wavelength-dependent separation of light, in particular from laser beams.

The dichroic mirror can be designed to reflect the first light having the first wavelength on the first optical path, and to transmit the second light having the second wavelength on the second optical path. This means that the path of the first light is deflected and thus undergoes a geometric change. The second light may continue on its path.

It is possible for the first wavelength of the light to be approximately 905 nm or approximately 1550 nm. The same applies for the second wavelength of the light. The use of various wavelengths makes it easily possible to efficiently separate the two optical paths by using the dichroic mirror, for example. The first and second wavelengths may be selected in such a way that both are in the range of approximately 905 nm or both are in the range of approximately 1550 nm. The first wavelength may be specified by the lidar sensor, namely, as the wavelength at which the lidar sensor operates. The second wavelength may be selected in such a way that separation of the optical paths by the dichroic mirror is made possible, but the lidar sensor perceives received second light having the second wavelength as a reflection of its emitted first light, for example due to the small difference from the first wavelength. In this way, the surroundings for the lidar sensor may be simulated and the lidar sensor may be tested.

The described device for testing the lidar sensor may include a test stand, in particular a roller test stand, for a vehicle having a lidar sensor. It is thus possible to cost-effectively test the lidar sensor in the installed state. In particular, a particularly compact design of the test stand is made possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of the device;

FIG. 2 shows a schematic illustration of an example of the transmitting device together with a movement device;

FIG. 3 shows a schematic illustration of an example of the transmitting device together with a driven mirror;

FIG. 4 shows a schematic illustration of a test stand; and

FIG. 5 shows a flow chart of the method.

### DETAILED DESCRIPTION

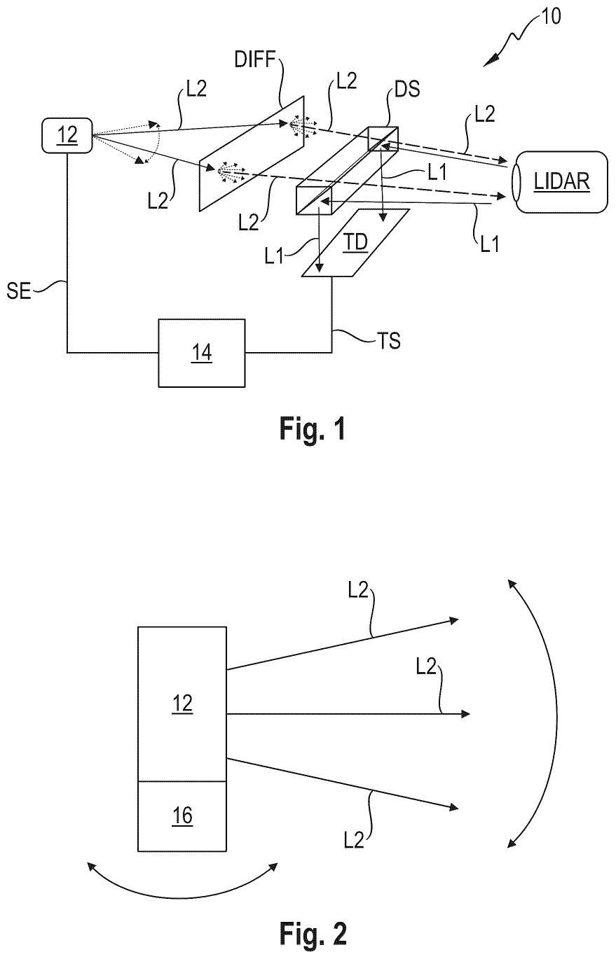

FIG. 1 shows a device 10, and a lidar sensor LIDAR that emits first light L1. The device 10 tests the lidar sensor LIDAR via the air, i.e., wirelessly and in particular via the optical interface of the lidar sensor. The lidar sensor LIDAR may, for example, already be installed in a vehicle 20.

The lidar sensor LIDAR sends first light L1 having a first wavelength into the device 10, and the first light L1 strikes the first optical element DS. The first light L1 is deflected by an optical element DS onto a trigger detector TD. The first optical element DS is designed as a dichroic mirror that is configured to reflect light having the first wavelength.

The trigger detector TD receives the first light L1 and converts it into an electrical signal by means of an optical-electrical converter which includes a photodiode or PIN diode, for example. The electrical signal is processed in the trigger detector TD, and generates a trigger signal TS as a function of the electrical signal. The processing may involve signal conditioning in which the trigger signal TS is generated from the first light L1. Signal processing may take place which includes smoothing and/or amplification and also more. The processing in the trigger detector TD may also include, for example, pattern recognition and/or analysis of the first light L1 converted into an electrical signal, using one or more threshold values.

For the processing, the trigger detector TD may have a signal processor, for example a processor, wherein the signal processor generates the trigger signal TS from the received light L1.

The trigger signal TS is transferred to an object simulator 14 via an electrical line, for example. It is also possible for the transfer of the trigger signal TS to be achieved via an optical signal or a radio signal, for example. The object simulator 14 may then include corresponding converters for converting the trigger signal TS into an electrical signal, which the object simulator 14 may process electrically.

The processing in the object simulator 14 may include, for example, recognizing that the lidar sensor LIDAR has emitted the first light L1, and the solid angle at which the emission took place. Based on this solid angle, the lidar sensor LIDAR would then also anticipate the return signal. The object simulator 14 can now simulate the surroundings for the lidar sensor LIDAR by simulating objects in the surroundings of the lidar sensor LIDAR and transferring a corresponding control signal SE to the transmitting device 12. The simulated objects may then be simulated by the transmitting device 12 for the lidar sensor LIDAR via emitted second light L2.

As a function of the trigger signal TS, the object simulator 14 thus generates the control signal SE, which the object simulator 14 electrically transfers to the transmitting device 12. Here as well, other forms of transfer such as by optics or via radio would be possible. In the present case a hard-wired transfer is used.

The transmitting device 12, as a function of the control signal SE, sends second light L2 in the direction of the second optical element DIFF, which is designed as a diffuser, for example. The at least one transmitting device 12 includes a light source, for example a laser array or a laser projector. The light source may be activated differently, wherein, for example, the individual laser diodes in a laser array may also be individually activatable. The light source may also be mechanically movable, for example, in particular rotatable. The radiation direction of the second light L2 and the location where it strikes the second optical element may be changed in this way.

The second light L2 may strike the second optical element DIFF at various locations and at various angles. The second optical element DIFF brings about a diffuse transmission of the second light L2 via the second optical element. Due to the diffuse transmission, the second light L2 is scattered in all possible directions, also in the direction of the first optical element DS, which is transparent to the second light L2 having the second wavelength. This portion of the second light L2 that is transferred by the first optical element DS strikes the lidar sensor LIDAR.

When in another embodiment the at least one transmitting device 12 is situated on the other side of the second optical element DIFF, the second optical element may be selected, for example, as a screen having diffuse reflection. Due to the diffuse reflection, the second light L2 is then reflected in all possible directions with scattering, also in the direction of the first optical element DS, which is transparent to the second light L2. This portion of the second light that is transferred by the first optical element DS strikes the lidar sensor LIDAR.

The second light L2 is emitted at a second wavelength. The second wavelength differs from the first wavelength such that the second light L2 is guided by the optical element DS, which is designed as a dichroic mirror. The optical element DS is designed in such a way that it allows light of the second wavelength to pass through. The second light L2 thus passes through the dichroic mirror, and then strikes the lidar sensor LIDAR on the side of the optical element DS facing the lidar sensor LIDAR. The second light L2 is received by the lidar sensor LIDAR, converted into an electrical signal, and further processed. The second wavelength is selected in such a way that it is far enough away from the first wavelength to enable the separation by the optical element DS. The second wavelength is likewise selected in such a way that it is close enough to the first wavelength to be perceived by the lidar sensor LIDAR as a reflection of the emitted first light L1. The simulation of objects is then enabled, and the lidar sensor LIDAR may be tested.

The processing of the control signal SE by the transmitting device 12 may also include pattern recognition, for example, wherein further factors may have an additional effect on the emitted second light L2. These factors include the objects that are to be simulated by the transmitting devices 12. These objects are generated by the object simulator 14, for example, and are communicated to the transmitting device 12 via the control signal SE.

The object simulator 14 is used to simulate the objects that the lidar sensor LIDAR is intended to be able to see in its visual range, for example to test the lidar sensor LIDAR. The objects are simulated in such a way that via the transmitting devices 12, artificial reflection signals are emitted by second light L2 that is generated in the transmitting devices 12. Various objects, object locations, object sizes, and/or object characteristics may be simulated using the second light L2. The lidar sensor LIDAR may thus be tested for whether the lidar sensor LIDAR can receive, distinguish, and identify all of these test objects that are simulated by the transmitting devices 12. This later makes it possible to correctly guide a vehicle 20 as a function of its surroundings, which have been detected by the lidar sensor LIDAR, or by providing a driver with information about what actions to take.

FIG. 2 schematically shows a transmitting device 12 with light beams L2 emitted in different directions. The diffuser DIFF ensures that a portion of the second light L2 is still reflected via the scattering in the direction of the lidar sensor LIDAR, even for a portion of the second light L2 that would not strike the lidar sensor LIDAR without the diffuser. On the other side, a portion of the second light L2 that would strike the lidar sensor LIDAR is also scattered by the diffuser DIFF in such a way that this portion ultimately will not strike the lidar sensor LIDAR.

The illustrated movement device 16 carries out swiveling of the transmitting device 12. As a result, the light beams L2 are emitted in these various directions as illustrated. The movement by the movement device 16 may be carried out via an electric motor. By use of the second optical element DIFF, a change in location of an object that is simulated for the lidar sensor LIDAR may take place solely by means of such swiveling. The radiation direction of the second light L2, and thus the possible second path, may have a large width, since reception of second light L2 by the lidar sensor LIDAR is made possible by the second optical element DIFF.

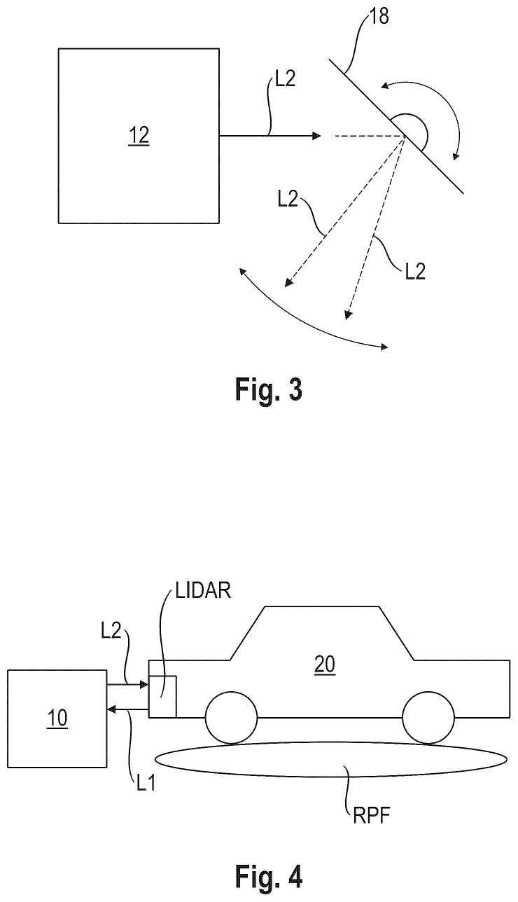

FIG. 3 shows a further schematic illustration of the transmitting device 12 which emits the second light L2. The second light L2 strikes a driven mirror 18, for example a galvo mirror, which is movable and which can therefore reflect the second light L2 at different angles, depending on the movement. The mirror 18 is moved by means of an electric motor. In this configuration, the transmitting device 12 remains mechanically unchanged. The transmitting device delivers only the second light L2, and via the mirror 18 the second light L2 then strikes the second optical element DIFF at different angles as a function of the movement of the mirror 18.

By use of the second optical element DIFF, a change in location of an object that is simulated for the lidar sensor LIDAR may take place solely by deflection of the second light L2 by the driven mirror 18. The radiation direction of the second light L2, and thus the possible second path, may have a large width, since reception of second light L2 by the lidar sensor LIDAR is made possible by the second optical element DIFF.

In some embodiments, it is possible to move both the transmitting device 12 and a mirror 18. This provides more options for testing.

FIG. 4 shows a test stand together with the device 10. A vehicle 20 includes the lidar sensor LIDAR, which emits the first light L1 into the device 10. The lidar sensor LIDAR receives the second light L2 from the device 10. The vehicle 20 rests on a roller test stand RPF, via which the vehicle 20 may be moved at a certain speed and acceleration. In this way scenarios, for example for autonomous driving, may be tested which can verify the functional capability of the lidar sensor LIDAR. In the present case, the lidar sensor LIDAR is in its actual installed position in the vehicle 20, for example in or at the headlights, in or at the bumper or other elements at the front end of the vehicle. Some other arrangement, for example at the upper edge of the windshield, is also possible. The lidar sensor LIDAR and/or further lidar sensors may be situated in other areas of the vehicle 20. The device 10 may then be situated appropriately in the visual field of the lidar sensor for testing.

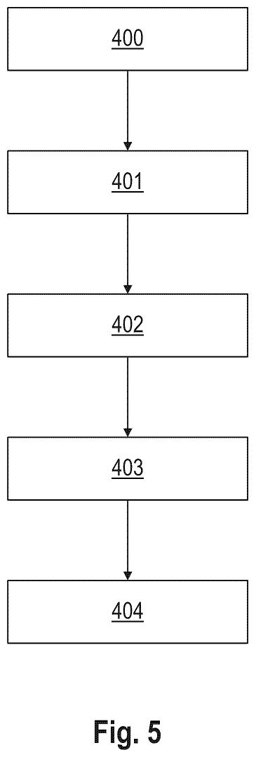

FIG. 5 shows a flow chart of one exemplary embodiment of the method for testing the lidar sensor LIDAR.

The lidar sensor LIDAR outputs the first light L1 having the first wavelength on a first optical path in method step 400.

The trigger detector TD receives the first light L1 on the first optical path in method step 401. After step 400 and before step 401, the first light L1 received by the trigger detector TD on the first optical path has passed through the optical element DS.

The trigger detector TD generates the trigger signal TS in method step 402 as a function of the received first light L1.

In method step 403 the object simulator 14 generates the control signal SE as a function of the trigger signal TS, and transfers the control signal SE to the transmitting device 12, which emits the second light L2 having the second wavelength on the second optical path as a function of the control signal SE. The generation of the control signal SE as a function of the trigger signal TS is carried out by the object simulator 14, as described with reference to FIG. 1, for example.

The second light L2 is received on the second optical path by the lidar sensor LIDAR in method step 404. After step 403 and before step 404, the second light L2 received on the second optical path by the lidar sensor LIDAR has passed through the optical element DS.

The lidar sensor LIDAR can then generate a reception signal. As a function of this reception signal, the lidar sensor LIDAR can generate a test signal or some other output signal, for example, on the basis of which the success of the testing of the lidar sensor LIDAR may be assessed.

The second optical element DIFF, which the second light L2 in the second optical path strikes before or after the first optical element DS, subjects the second light L2 to a diffuse reflection and/or transmission.

By use of the second optical element DIFF, it is possible to easily simulate objects at various locations by means of the transmitting device 12. Due to use of the second optical element DIFF, for simulation of various objects it may be sufficient to change the direction of the second light L2. A change in location of a simulated object may thus also be simulated for the lidar sensor LIDAR by projection onto the second optical element DIFF. This may result in lower mechanical demands on the transmitting unit, and a more compact device 10 is possible.

The first optical element DS may be situated in the first optical path and the second optical path. The first optical element DS separates the first optical path and the second optical path in such a way that the first optical path and the second optical path run crosswise relative to one another after the separation. This separation takes place using the particular wavelengths of the first light and the second light, for example using a dichroic mirror or some other optical element that operates based on wavelengths.

The first optical path of step 400 and the second optical path of step 404 may thus extend in parallel or essentially in parallel to one another, so that a realistic reception situation may be simulated for the lidar sensor LIDAR. The first optical path of step 401 and the second optical path of step 403 may thus run crosswise relative to one another, so that the trigger detector TD and the transmitting device 12 can be situated apart from one another. The second optical element DIFF may preferably be situated in the portion of the second path that extends separately from the first path. In this way, the second optical element DIFF may act on the second light in a targeted manner

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for testing a lidar sensor, the lidar sensor being configured to emit a first light having a first wavelength, the device comprising:
a trigger detector configured to receive the first light on a first optical path, the trigger detector being configured to generate a trigger signal as a function of the received first light;
at least one transmitter configured to emit a second light, the at least one transmitter having a second wavelength, as a function of the trigger signal, the second light being receivable on a second optical path by the lidar sensor;
a first optical element configured to separate the first optical path from the second optical path; and
a second optical element that is arranged in the second optical path and that is configured to apply a diffuse reflection and/or transmission to the second light.

2. The device according to claim 1, wherein the second optical element is configured to apply the diffuse reflection and/or transmission to the second light in the second optical path on the side of the first optical element facing away from the lidar sensor, wherein the first optical path and the second optical path are separated on the side of the first optical element facing away from the lidar sensor.

3. The device according to claim 1, wherein the second optical element includes a diffuser or a screen.

4. The device according to claim 1, wherein a change device is provided which is configured to change the direction of the second light as a function of the object simulator.

5. The device according to one of the preceding claims, wherein the change device is a further optical element in the second optical path.

6. The device according to claim 4, wherein the change device includes an electromagnetically driven mirror or a galvo mirror.

7. The device according to claim 1, wherein the change device includes a movement device that is designed to change the direction of transmission of the second light via a movement of at least one light source of the at least one transmitter.

8. The device according to claim 7, wherein the at least one transmitter includes a projector.

9. The device according to claim 1, wherein the at least one transmitter includes a field of light sources, the light sources being activatable independently of one another.

10. The device according to claim 1, wherein the at least one transmitter and the trigger detector are arranged spatially separate from one another.

11. The device according to claim 1, wherein the first wavelength is not equal to the second wavelength, and wherein the separation of the first optical path and of the second optical path by the first optical element is a function of the wavelength.

12. The device according to claim 11, wherein the optical element is a dichroic mirror.

13. A test stand for a vehicle comprising:
a lidar sensor; and
the device according to claim 1.

14. The test stand according to claim 13, wherein the test stand is a roller test stand.

15. A method for testing a lidar sensor, the method comprising:
emitting a first light having a first wavelength, by the lidar sensor;
receiving the first light on a first optical path by a trigger detector;
generating a trigger signal by the trigger detector as a function of the received first light;
emitting a second light, having a second wavelength, by at least one transmitter as a function of the trigger signal;
receiving the second light on a second optical path by the lidar sensor;
separating, via a first optical element, the first optical path from the second optical path; and
applying, via a second optical element, a diffuse reflection and/or transmission to the second light in the second optical path.

16. The method according to claim 15, wherein the second optical element applies the diffuse reflection and/or transmission to the second light in the second optical path on the side of the first optical element facing away from the lidar sensor, wherein the first optical path and the second optical path are separated on the side of the first optical element facing away from the lidar sensor.
